(19) United States
(12) Patent Application Publication
(10) Pub. No.: US 2025/0021393 A1
(43) Pub. Date: Jan. 16, 2025

(54) HEURISTIC PERFORMANCE METRIC HINTS

(71) Applicant: APPLE INC., Cupertino, CA (US)

(72) Inventor: Max Dmitrichenko, Munich (DE)

(21) Appl. No.: 18/351,555

(22) Filed: Jul. 13, 2023

(51) Int. Cl. G06F 9/50

(52) U.S. Cl. CPC G06F 9/5044

(57) ABSTRACT

In one embodiment, a device includes a memory configured to store data indicating performance metrics of hardware processing units, and a first hardware processing unit is configured to execute software code, which includes a processing job to be executed, select at least one of the hardware processing units to perform the processing job based on a given process type of the processing job and the performance metrics of the hardware processing units for the given process type, wherein the selected at least one hardware processing unit is configured to process the processing job.

### FIELD OF THE DISCLOSURE

The present disclosure relates to computer systems, and in particular, but not exclusively, to metric-based processor selection.

### BACKGROUND

Traditionally, computer systems are designed to customarily and separately handle different processing tasks. For example, central processing units (CPU) are designed to handle general purpose processes, graphics processing units (GPU) are designed to handle graphics-related processes, and digital signal processing units (DSP) are designed to handle digital signal computational processes.

Further, as the operating power consumption of individual components of a typical computer system creep upwards, the power budget of such a system has become tighter. It is now becoming a challenge to design a computer system to simultaneously achieve various high-performance goals, such as high computing power, compactness, quietness, better battery performance, etc. For example, portable computer systems, such as laptop computers, have a limited battery output capability; and thus, a given battery output capability may limit a system from performing at a continuous high-performance capability with dedicated processing units for certain computational processes.

Traditional power management systems rely heavily on throttling to manage power consumption. Virtually all power management systems employ reduction of process performance, in one form or another, in order to reduce power consumption. The reduction in power consumption is achieved by selecting different states of operation (e.g., frequency and operating voltage of main processor) depending upon the desired state of the system; for example, if reduced power consumption is desired, the main processor is operated at a reduced frequency and is supplied a reduced operating voltage. These states of different frequencies and voltages are preselected when a system is designed; in other words, a designer of a system selects hardware components and designs software to provide these different states when a system is built with these components and software.

### SUMMARY

There is provided in accordance with an embodiment of the present disclosure, a device including a memory configured to store data indicating performance metrics of a plurality of hardware processing units, and a first hardware processing unit is configured to execute software code, which includes a processing job to be executed, select at least one of the hardware processing units from the plurality of hardware processing units to perform the processing job based on a given process type of the processing job and the performance metrics of the hardware processing units for the given process type, wherein the selected at least one hardware processing unit is configured to process the processing job.

Further in accordance with an embodiment of the present disclosure the hardware processing units include at least one of a central processing unit (CPU), a graphics processing unit (GPU), a video decoder, a matrix multiplication unit, a neural engine block, an encryption engine, a decryption engine, or a hardware accelerator.

Still further in accordance with an embodiment of the present disclosure the data includes metric descriptor fingerprints and corresponding performance metrics.

Additionally in accordance with an embodiment of the present disclosure one of the metric descriptor fingerprints includes any one or more of the following a metric name, a processing unit identifier, a process type, a performance domain, a metric creator identifier, and a metric creation timestamp.

Moreover, in accordance with an embodiment of the present disclosure one or the performance metrics includes one or more of the following a processing speed metric, a latency metric, a power consumption metric, a performance metric based on processing speed and latency, and a performance metric based on processing speed, latency, and power consumption.

Further in accordance with an embodiment of the present disclosure, the device includes a second hardware processing unit, wherein the second hardware processing unit is configured to cause a test process to be processed on at least some of the hardware processing units, the at least some hardware processing units are configured to process the test process, the second hardware processing unit is configured to perform measurements related to performance of the at least some hardware processing units processing the test process, and the second hardware processing unit is configured to update the data of the performance metrics responsively to the performed measurements.

Still further in accordance with an embodiment of the present disclosure, the device includes a first die, a second die, and a data communication bus between the first die and second die, wherein the hardware processing units include a second hardware processing unit disposed on the first die and a third hardware processing unit disposed on the second die, the first hardware processing unit being configured to select the second hardware processing unit to perform at least part of the processing job based on the given process type of the processing job, and the performance metrics of the second hardware processing unit and the third hardware processing unit for the given process type.

Additionally in accordance with an embodiment of the present disclosure, the device includes a system-on-chip including a first chiplet and a second chiplet, wherein the hardware processing units include a second hardware processing unit disposed on the first chiplet and a third hardware processing unit disposed on the second chiplet, the first hardware processing unit being configured to select the second hardware processing unit to perform at least part of the processing job based on the given process type of the processing job and the performance metric of the second hardware processing unit and the third hardware processing unit for the given process type.

Moreover, in accordance with an embodiment of the present disclosure the selected at least one hardware processing unit includes a second hardware processing unit and a third hardware processing unit, the first hardware processing unit being configured to apportion the processing job between the second hardware processing unit and the third hardware processing unit a ratio of the performance metrics of the second hardware processing unit to the third hardware processing unit.

Further in accordance with an embodiment of the present disclosure the first hardware processing unit is configured to select the at least one hardware processing unit based on a maximum allowed latency of the processing job and at least one latency metric of the performance metrics of the hardware processing units for the given process type.

Still further in accordance with an embodiment of the present disclosure the selected at least one hardware processing unit includes a second hardware processing unit and a third hardware processing unit, the first hardware processing unit is configured to apportion the processing job between the second hardware processing unit and the third hardware processing unit of the hardware processing units a ratio of processing speed metrics of the performance metrics of the second hardware processing unit to the third hardware processing unit.

Additionally in accordance with an embodiment of the present disclosure the first hardware processing unit is configured to select the at least one hardware processing unit based on at least one power consumption metric of the performance metrics of the hardware processing units for the given process type.

Moreover, in accordance with an embodiment of the present disclosure the first hardware processing unit is configured to select the at least one hardware processing unit based on the at least one power consumption metric responsively to the device being in a power save mode.

Further in accordance with an embodiment of the present disclosure the first hardware processing unit is configured to run an operating system on which to execute the software code, which includes the processing job to be executed, the operating system being configured to select the at least one hardware processing units to perform the processing job based on the given process type of the processing job and the performance metrics of the hardware processing units for the given process type.

Still further, in accordance with an embodiment of the present disclosure the operating system is configured to cause the at least one hardware processing unit to process the processing job.

There is also provided in accordance with another embodiment of the present disclosure, a method, including storing data indicating performance metrics of hardware processing units, executing software code, which includes a processing job to be executed, selecting at least one of the hardware processing units to perform the processing job based on a given process type of the processing job and the performance metrics of the hardware processing units for the given process type, and causing the at least one hardware processing unit to process the processing job.

There is also provided in accordance with still another embodiment of the present disclosure, an integrated circuit, including a memory configured to store data indicating performance metrics of hardware processing units, and a first hardware processing unit configured to execute software code, which includes a processing job to be executed, select at least one of the hardware processing units to perform the processing job based on a given process type of the processing job and the performance metrics of the hardware processing units for the given process type, and cause the at least one hardware processing unit to process the processing job.

Additionally in accordance with an embodiment of the present disclosure the hardware processing units include at least one of a central processing unit (CPU), a graphics processing unit (GPU), a video decoder, a matrix multiplication unit, a neural engine block, an encryption engine, a decryption engine, or a hardware accelerator.

Moreover, in accordance with an embodiment of the present disclosure the data includes metric descriptor fingerprints and corresponding performance metrics.

Further in accordance with an embodiment of the present disclosure one of the metric descriptor fingerprints includes any one or more of the following a metric name, a processing unit identifier, a process type, a performance domain, a metric creator identifier, and a metric creation timestamp.

Still further in accordance with an embodiment of the present disclosure one or the performance metrics includes one or more of the following a processing speed metric, a latency metric, a power consumption metric, a performance metric based on processing speed and latency, and a performance metric based on processing speed, latency, and power consumption.

Additionally in accordance with an embodiment of the present disclosure, the integrated circuit includes a second hardware processing unit, wherein the second hardware processing unit is configured to cause a test process to be processed on at least some of the hardware processing units, the at least some hardware processing units are configured to process the test process, the second hardware processing unit is configured to perform measurements related to performance of the at least some hardware processing units processing the test process, and the second hardware processing unit is configured to update the data of the performance metrics responsively to the performed measurements.

Moreover, in accordance with an embodiment of the present disclosure the selected at least one hardware processing unit includes a second hardware processing unit and a third hardware processing unit, the first hardware processing unit being configured to apportion the processing job between the second hardware processing unit and the third hardware processing unit a ratio of the performance metrics of the second hardware processing unit to the third hardware processing unit.

Further in accordance with an embodiment of the present disclosure the first hardware processing unit is configured to select the at least one hardware processing unit based on a maximum allowed latency of the processing job and at least one latency metric of the performance metrics of the hardware processing units for the given process type.

Still further in accordance with an embodiment of the present disclosure the selected at least one hardware processing unit includes a second hardware processing unit and a third hardware processing unit, the first hardware processing unit is configured to apportion the processing job between the second hardware processing unit and the third hardware processing unit of the hardware processing units a ratio of processing speed metrics of the performance metrics of the second hardware processing unit to the third hardware processing unit.

Additionally in accordance with an embodiment of the present disclosure the first hardware processing unit is configured to select the at least one hardware processing unit based on at least one power consumption metric of the performance metrics of the hardware processing units for the given process type.

Moreover, in accordance with an embodiment of the present disclosure the first hardware processing unit is configured to select the at least one hardware processing unit based on the at least one power consumption metric responsively to the integrated circuit being in a power save mode.

### BRIEF DESCRIPTION OF THE DRAWINGS

The present invention will be understood from the following detailed description, taken in conjunction with the drawings in which:

FIG. 1 is a block diagram view of a device constructed and operative in accordance with an embodiment of the present invention;

FIG. 2 is a view of performance metric(s) and descriptor for use in the device of FIG. 1;

FIG. 3 is a table showing example performance metrics and descriptors for use in the device of FIG. 1;

FIG. 4 is a block diagram view of part of the device of FIG. 1 computing performance metrics;

FIG. 5 is a flowchart including steps in a method to compute performance metrics in the device of FIG. 1;

FIG. 6 is a block diagram view of part of the device of FIG. 1 processing a processing job; and

FIG. 7 is a flowchart including steps in a method to process a processing job in the device of FIG. 1.

### DESCRIPTION OF EXAMPLE EMBODIMENTS

### Overview

Modern devices may include many processors available for performing different processing jobs. In fact, a processing job may be performed by more than one processor. For example, a central processing unit (CPU) or a video decoding unit may be used to decode video. However, it is not obvious which processor should be selected to perform a particular processing job as the various performance factors are complex.

Embodiments of the present invention address some of the above drawbacks by providing a device which selects which processing unit(s) to select to process a processing job of a given process type (e.g., decoding, decryption, matrix multiplication etc.) based on given performance metrics of hardware processing units (e.g., CPUs, graphics processing units (GPUs), video decoders, decryption engines etc.) of the device for that given process type. The processing job may be part of a main process being run by a processor of the device, such as a CPU executing software, which includes the processing job.

For example, if a video decoding job needs to be processed and the device includes two processing units to perform video decoding, e.g., a CPU and a dedicated video decoder, the device may select between the CPU or the video decoder depending on performance metrics of the CPU and the video decoder. For example, if low latency or low power consumption is important, then the device may select the processing unit(s) having the lower latency or power consumption metrics. If high processing speed is important, the device may select the processing unit(s) having the highest processing speed metrics.

In some embodiments, a processing job may be apportioned between two or more processing units based on the performance metrics of the selected processing units. For example, if a video decoding job needs to be processed and the device includes two processing units to perform video decoding, e.g., a CPU and a dedicated video decoder, the device may apportion the processing job between the CPU and the video decoder so that part of the job is performed by the CPU and part of the job is performed by the video decoder according to a ratio of performance metrics (e.g., processing speed) of the CPU and the video decoder. For example, if the video decoder can decode video twice as fast as the CPU, one third of the video decoding job may be assigned to the CPU and two thirds to the video decoder resulting in the job completing about the same time (while ignoring other latency issues).

In some embodiments, the device may select a processing unit on one chiplet over a processing unit on another chiplet to perform a processing job based on the performance metrics of the processing units on the chiplets. In some embodiments, the device may select a processing unit on one die over a processing unit on another die to perform a processing job based on the performance metrics of the processing units on the dies. For example, a processing unit on one die or chiplet may have lower latency due to an intrinsic latency of the processing unit or due to latency between the processing unit and the CPU managing the main process.

In some embodiments, the device may store the performance metrics using a metric descriptor fingerprint and a corresponding performance metric or metrics. The metric descriptor fingerprint may include any one or more of the following: a metric name (e.g., CPU1 used for decoding video, GPU2 for graphics processing); a processing unit identifier (e.g., CPU1, GPU2); a process type (e.g., video decoding, matrix multiplication, decryption); a performance domain (e.g., latency, power consumption, processing speed or any suitable combination thereof); a metric creator identifier (e.g., Apple or John Smith); and a metric creation timestamp (e.g., May 1, 2023 at 18:00). The performance metrics includes one or more of the following: a processing speed metric; a latency metric; a power consumption metric; a performance metric based on processing speed and latency; and a performance metric based on processing speed, latency, and power consumption.

In some embodiments, the performance metrics may be generated or updated by the device based on the device causing test processes to be run on different processing units for different process types and measuring the results of the processes in terms of latency, power consumption, and processing speed etc., in order to determine the performance metrics for the different processing units for the different process types.

### System Description

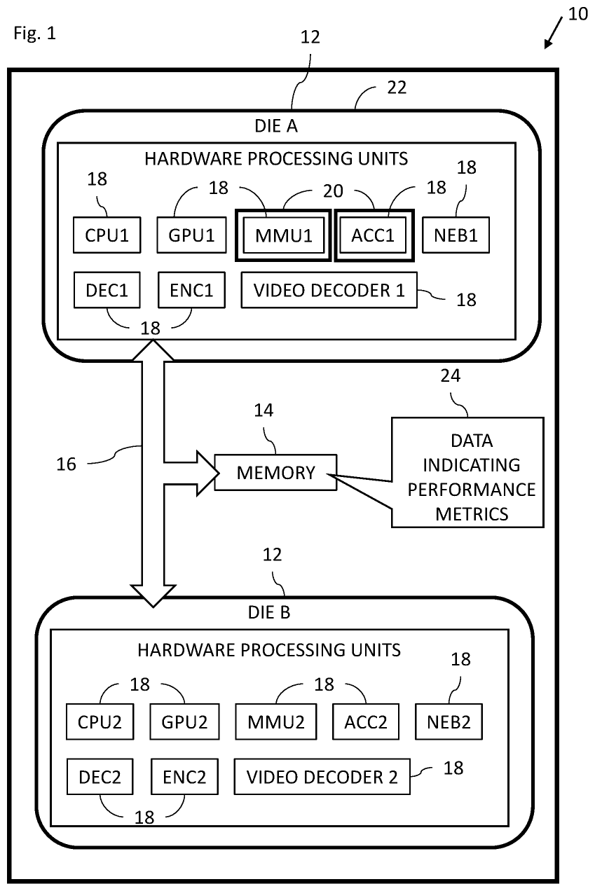

Reference is now made to FIG. 1, which is a block diagram view of a device 10 constructed and operative in accordance with an embodiment of the present invention. Device 10 may be any suitable device, for example, a personal computer, a mobile phone, a tablet device, a television set-top box, or a gaming device. The device includes one or more dies 12, a memory 14, and a data communication bus 16 connecting the dies 12 and the memory 14 for data connection purposes. FIG. 1 shows that the device 10 includes two dies 12, die A and die B. The device 10 may include other components (not shown) such as any one or more of the following: one or more displays; user input devices, such as a keyboard, mouse, and/or touch-sensitive screen; wireless and cellular communication hardware; and/or storage devices such as flash storage and/or other disk drives by way of example.

The device 10 includes hardware processing units 18, which may be selected from any suitable selection of hardware processors such as CPU(s), GPU(s), video decoder(s), matrix multiplication unit(s) (MMU(s)), hardware accelerators (ACC(s)), neural engine block(s) (NEB(s)), decryption engine(s) (DEC(s)), and/or encryption engine(s) (ENC(s)). One or more of the hardware processing units 18 may be comprised in a chiplet 20 such that the device 10 includes a system-on-chip 22 including one or more chiplets 20.

In the example of FIG. 1, die A includes some of the hardware processing units 18 disposed thereon, and die B includes some of the hardware processing units 18 disposed thereon. Die A includes CPU1, GPU1, MMU1, ACC1, NEB1, DEC1, ENC1, VIDEO DECODER 1. Die B includes CPU2, GPU2, MMU2, ACC2, NEB2, DEC2, ENC2, VIDEO DECODER 2. Device 10 may include any suitable number of dies with any suitable number and type of processors on the dies. For example, one die may include 3 CPUs and 2 GPUs. In the example of FIG. 1, device 10 includes two chiplets 20 disposed on die A, with MMU1 disposed on one chiplet 20, and ACC1 disposed on another chiplet 20.

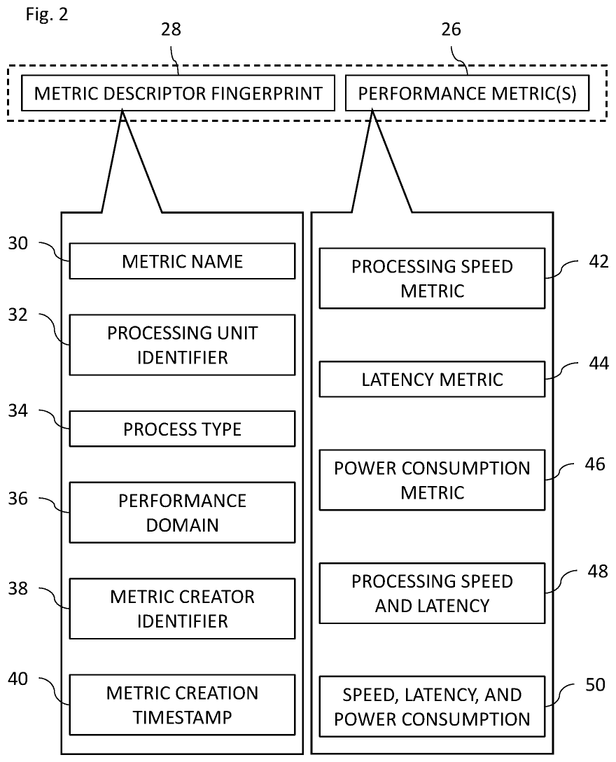

Memory 14 is configured to store data 24 indicating performance metrics of the hardware processing units 18 for different process types. The performance metrics and the different process types are described in more detail with reference to FIG. 2.

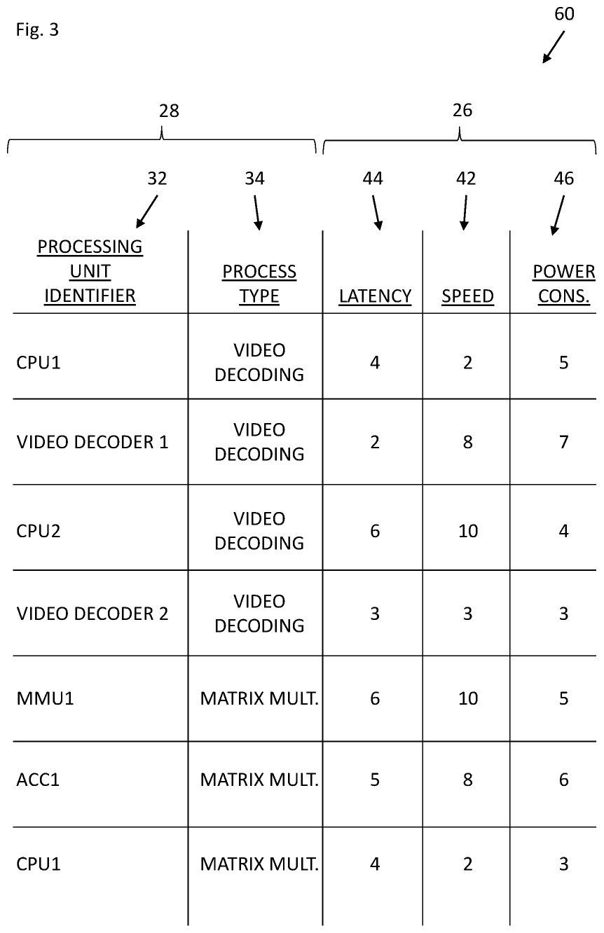

Reference is now made to FIG. 2, which is a view of performance metric(s) 26 and a metric descriptor fingerprint 28 for use in device 10 of FIG. 1. In some embodiments, device 10 may store the performance metrics 26 using metric descriptor fingerprints 28 and corresponding performance metrics 26. The performance metrics 26 and metric descriptor fingerprints 28 are stored in data 24 in memory 14. The data 24 includes multiple metric descriptor fingerprints 28 and associated performance metric(s) 26 for each of the metric descriptor fingerprints 28. Example metric descriptor fingerprints 28 and associated performance metrics 26 are described with reference to FIG. 3.

The metric descriptor fingerprint 28 may include any one or more of the following: a metric name 30 (e.g., CPU1 used for decoding video, GPU2 for graphics processing, Decoder 2 for high definition video decoding); a processing unit identifier 32 (e.g., CPU1, GPU2, ACC1); a process type 34 (e.g., high definition video decoding, matrix multiplication, decryption, neural network operation, encryption, general processing); a performance domain 36 (e.g., latency, power consumption, processing speed or any suitable combination thereof); a metric creator identifier 38 (e.g., Apple, John Smith); and a metric creation timestamp 40 (e.g., May 1, 2023 at 18:00).

The performance metric(s) 26 may include one or more of the following: a processing speed metric 42; a latency metric 44; a power consumption metric 46; a performance metric based on processing speed and latency 48; and a performance metric based on processing speed, latency, and power consumption 50.

The processing speed metric 42 may be given in any suitable unit, for example, frames per second, megahertz, gigahertz, etc. The latency metric 44 may be measured in any suitable unit of time, e.g., nanoseconds or clock cycles etc. The power consumption metric 46 may be measured in any suitable unit of energy or power consumption such as Joules or Watts per second. The performance metric based on processing speed and latency 48 is an index providing a measure of combined speed and latency that may be combined using any suitable function which may weight one of the factors more than the other. The performance metric based on processing speed, latency, and power consumption 50 is an index providing a measure of combined speed, latency, and power consumption that may be combined using any suitable function which may weight one of the factors more than the other. Other metrics and metric combinations are possible.

For example, the same hardware processing unit 18 (e.g., CPU1) may have performance metric(s) 26 for one process type 34 (e.g., general processing) and other performance metric(s) 26 for another process type 34 (e.g., video decoding).

In some embodiments, one of the metric descriptor fingerprints 28 may be associated with a single performance metric 26 such as latency. For example, the data 24 may include a metric descriptor fingerprint 28 for CPU1 for decoding and an associated performance metric 26 for latency, and include another metric descriptor fingerprint 28 for CPU1 for decoding and an associated performance metric 26 for power consumption.

In other embodiments, the data 24 may include multiple performance metrics 26 for a single metric descriptor fingerprint 28. For example, the data 24 may include a metric descriptor fingerprint 28 for CPU1 for decoding and associated performance metrics 26 for latency and power consumption etc.

Reference is now made to FIG. 3, which is a table 60 showing example performance metrics 26 and metric descriptor fingerprints 28 for use in the device 10 of FIG. 1. Reference is also made to FIG. 1. By way of example, each metric descriptor fingerprint 28 includes processing unit identifier 32 and process type 34. The associated performance metrics 26 for each metric descriptor fingerprint 28 includes latency metric 44, processing speed metric 42, and power consumption metric 46. Each line of the table 60 includes a different metric descriptor fingerprint 28 and associated performance metrics 26. The first line of table 60 includes: metric descriptor fingerprint 28 for CPU1 for the process type 34 of video decoding; and performance metrics 26 equal to 4 for latency, 2 for speed, and 5 for power consumption.

Examples follow which use the example performance metric(s) 26 in the table 60 to allow the device 10 to select hardware processing unit(s) 18 to perform different processing jobs. By way of example, the device 10 needs to process a processing job for video decoding. The processing job also has a maximum allowed latency of 4. A search of table 60 reveals that there are four hardware processing units 18 which can perform video decoding (namely, CPU1, video decoder 1, CPU2, and video decoder 2). However, CPU2 has a latency of 6. Therefore, CPU2 is removed from the possible choice of hardware processing units 18 for performing this processing job. If processing speed is important, the device 10 may select video decoder 1 which has the highest processing speed of the hardware processing units 18 with the acceptable latency. If power consumption is important (e.g., the device 10 is set in power save mode), then device 10 may select video decoder 2 which has the lowest power consumption of the hardware processing units 18 with the acceptable latency.

In some cases, the device 10 may apportion the processing job between the hardware processing units 18 (with the acceptable latency) according to the performance metrics 26 of the hardware processing units 18. For example, the device 10 may apportion the video decoding between video decoder 1 and 2 according to the ratio of 8:3 (which is the ratio of the processing speed metric 42 of video decoder 1 to video decoder 2). The apportionment could also be performed among 3 or more hardware processing units 18.

It should be noted that the latency performance metrics 26 may reflect the location of the main process managing the processing job. For example, if CPU1 is running software including a decoding process to be performed, then the latency of video decoder 1 may be lower than the latency of video decoder 2 as video decoder 1 is on die A which is the same die including CPU1, whereas video decoder 2 is on die B and therefore there is additional latency transferring data from die B to die A over the data communication bus 16.

By way of another example, the device 10 needs to perform a processing job of matrix multiplication. Table 60 shows three processors that can perform matrix multiplication, namely MMU1, ACC1, and CPU1. MMU1 and ACC1 have higher processing speed and lower power consumption than CPU1 for matrix multiplication. However, the latency of MMU1 and ACC1 is higher than CPU1, which may be partly due to MMU1 and ACC1 being disposed on chiplets 20 whereas CPU1 is directly disposed on Die A. Therefore, if latency is more important, the device 10 may select CPU1 to perform the matrix multiplication, whereas if processing speed and/or power consumption is more important, the device 10 may select MMU1 and/or ACC1 to perform the matrix multiplication.

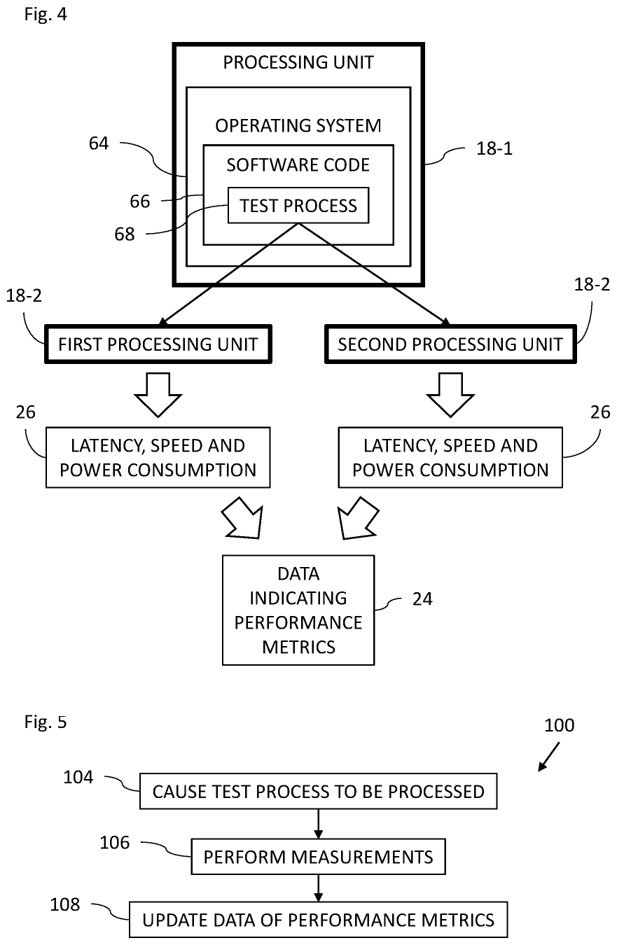

Reference is now made to FIGS. 4 and 5. FIG. 4 is a block diagram view of part of the device 10 of FIG. 1 computing performance metrics 26. FIG. 5 is a flowchart 100 including steps in a method to compute performance metrics 26 in the device 10 of FIG. 1. One of the hardware processing units 18-1 (e.g., CPU1) is configured to cause a test process 68 (e.g., a decoding process) to be processed on at least some given ones of the hardware processing units 18-2, 18-3 (e.g., decoder 1 and decoder 2) (block 104). For example, the test process 68 may be run on all (or a subset of) the hardware processing units 18 which can process the test process 68. In some embodiments, the hardware processing unit 18-1 (e.g., CPU1) is configured to run an operating system 64, which executes software code 66 with the test process 68 (e.g., a decoding process). The given hardware processing units 18-2, 18-3 are configured to process the test process 68 while the hardware processing unit 18-1 running the software code 66 is configured to perform measurements (e.g., of speed, latency, and power consumption) related to performance of the given hardware processing units 18-2, 18-3 processing the test process 68 (block 106). The hardware processing unit 18-1 is configured to update the data 24 of the performance metrics 26 (and optionally the metric descriptor fingerprints 28) responsively to the performed measurements (block 108). The above process may be repeated for different process types (e.g., matrix multiplication, decryption, encryption, graphics processing, general processing etc.).

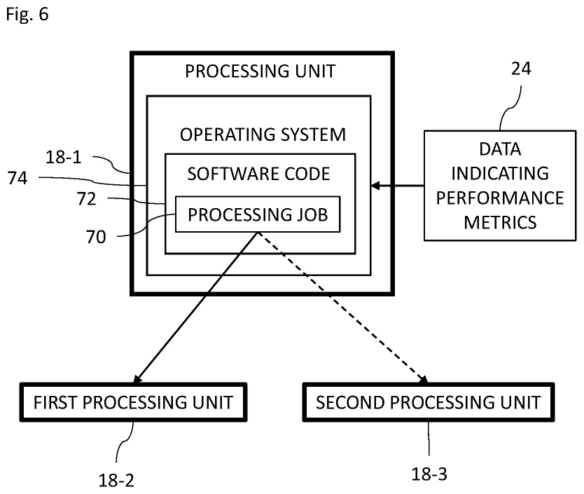

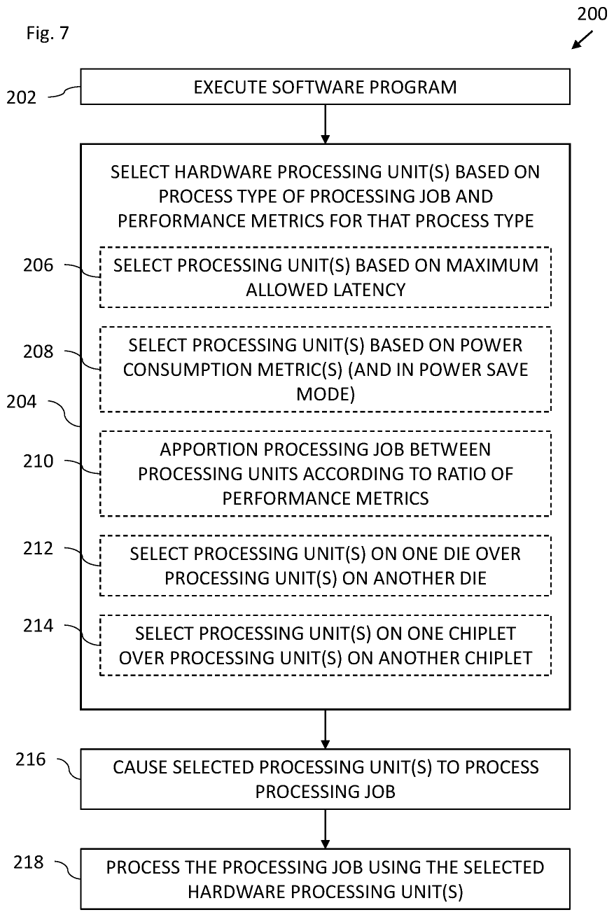

Reference is now made to FIGS. 6 and 7. FIG. 6 is a block diagram view of part of the device 10 of FIG. 1 processing a processing job 70. FIG. 7 is a flowchart 200 including steps in a method to process the processing job 70 in the device 10 of FIG. 1. The hardware processing unit 18-1 (e.g., CPU1 or CPU2 or another processor) is configured to execute software code 72, which includes the processing job 70 to be executed (block 202). In some embodiments, hardware processing unit 18-1 is configured to run an operating system 74 on which to execute the software code 72, which includes the processing job 70 to be executed.

The hardware processing unit 18-1 is configured to select at least one of the hardware processing units 18 (e.g., hardware processing units 18-2 and 18-3) from the plurality of hardware processing units 18 in the device 10 to perform the processing job 70 based on a given process type (e.g., decoding or decryption) of the processing job 70 and the performance metrics 26 of the hardware processing units 18 for the given process type (block 204). In some embodiments, the operating system 77 running on the hardware processing unit 18-1 is configured to select the hardware processing unit(s) 18 to perform the processing job 70 based on the given process type of the processing job 70 and the performance metrics 26 of the hardware processing units 18 for the given process type.

In some embodiments, the hardware processing unit 18-1 is configured to select the hardware processing unit(s) to process the processing job 70 based on a maximum allowed latency of the processing job 70 and the latency metric(s) 44 of the performance metrics 26 of the hardware processing units 18 for the given process type (block 206). In other words, the hardware processing unit 18-1 searches the data 24 for hardware processing units 18 having a latency metric less than, or equal to, the maximum allowed latency for the given process type. The hardware processing unit 18-1 may then select one or more hardware processing units 18 from the hardware processing units 18 having a latency metric less than, or equal to, the maximum allowed latency for the given process type. Optionally, the hardware processing unit 18-1 then applies other selection methods described below in more detail.

In some embodiments, the hardware processing unit 18-1 is configured to select the hardware processing unit(s) to process the processing job 70 based on power consumption metric(s) of the performance metrics 26 of the hardware processing units 18 for the given process type (block 208). In some embodiments, the hardware processing unit 18-1 is configured to select the hardware processing unit(s) based on the power consumption metric(s) responsively to the device 10 being in a power save mode. The selection based on power consumption metrics may be performed independently of, or in combination with selection based on latency. For example, the device 10 may select hardware processing unit(s) 18 with minimal latency and minimal power consumption or some other criteria.

In some embodiments, the hardware processing unit 18-1 is configured to apportion the processing job 70 among two or more hardware selected processing units 18 (e.g., between hardware processing units 18-2 and 18-3) according to a ratio of the performance metrics of the selected hardware processing units 18 (block 210). Apportioning the processing job 70 among two or more hardware processing units 18 may include dividing the processing job 70 into elements and providing some of the elements to one of the hardware processing units 18, and some of the elements to another one of the hardware processing units 18, and so on. Elements may include computations, video frames, matrices, plaintext blocks, ciphertext blocks, etc.

For example, the hardware processing unit 18-1 may be configured to apportion the processing job 70 among the selected hardware processing units 18 (e.g., between hardware processing units 18-2 and 18-3) based on a ratio of processing speed metrics of the performance metrics 26 of the selected hardware processing units 18. Prior to apportioning the processing job 70 among the selected hardware processing units 18, the selected hardware processing units 18 may have first been selected by the hardware processing unit 18-1 according to latency and/or power consumption metrics as described above. In a first example, the given process type of the processing job is video decoding, one of the selected hardware processing units 18 is a video decoder, and another one of the selected hardware processing units 18 is a CPU. In a second example, the given process type of the processing job is graphics processing, one of the selected hardware processing units 18 is a GPU, and another one of the selected hardware processing units 18 is a CPU. In a third example, the given process type of the processing job is matrix multiplication, one of the selected hardware processing units 18 is an MMU, and another one of the selected hardware processing units 18 is a CPU or accelerator. In a fourth example, the given process type of the processing job is decryption, one of the selected hardware processing units 18 is a decryption engine, and another one of the selected hardware processing units 18 is a CPU.

In some embodiments, the hardware processing unit 18-1 is configured to select one of the hardware processing units 18-2 on a first die to perform at least part of the processing job 70 based on the given process type of the processing job, and the performance metrics of the selected hardware processing unit 18-2 and at least another one of the hardware processing units 18-3 on a different die for the given process type (block 212). For example, the hardware processing unit 18-1 may select hardware processing units 18-2 on die A to perform at least part of the processing job 70 as it has lower latency metrics than a similar processor 18-3 on die B.

In some embodiments, the hardware processing unit 18-1 is configured to select one of the hardware processing units 18-2 on a first chiplet 20 to perform at least part of the processing job 70 based on the given process type of the processing job, and the performance metrics of the selected hardware processing unit 18-2 and at least another one of the hardware processing units 18-3 on a different chiplet 20 for the given process type (block 214). For example, the hardware processing unit 18-1 may select hardware processing units 18-2 on one chiplet to perform at least part of the processing job 70 as it has lower latency metrics than a similar processor 18-3 on another chiplet.

The operating system 74 running on the hardware processing unit 18-1 is configured to cause the at least one hardware processing unit to process the processing job (block 216). The selected hardware processing unit(s) 18 is configured to process the processing job 70 (block 218).

In practice, some or all of the functions of any of the hardware processing units 18 may be combined in a single physical component or, alternatively, implemented using multiple physical components. These physical components may comprise hard-wired or programmable devices, or a combination of the two. In some embodiments, at least some of the functions of any of the hardware processing units 18 may be carried out by a programmable processor under the control of suitable software. This software may be downloaded to a device in electronic form, over a network, for example. Alternatively, or additionally, the software may be stored in tangible, non-transitory computer-readable storage media, such as optical, magnetic, or electronic memory.

Various features of the invention which are, for clarity, described in the contexts of separate embodiments may also be provided in combination in a single embodiment. Conversely, various features of the invention which are, for brevity, described in the context of a single embodiment may also be provided separately or in any suitable sub-combination.

The embodiments described above are cited by way of example, and the present invention is not limited by what has been particularly shown and described hereinabove. Rather the scope of the invention includes both combinations and sub-combinations of the various features described hereinabove, as well as variations and modifications thereof which would occur to persons skilled in the art upon reading the foregoing description and which are not disclosed in the prior art.

What is claimed is:

1. A device comprising:
a memory configured to store data indicating performance metrics of a plurality of hardware processing units; and
a first hardware processing unit is configured to:
execute software code, which includes a processing job to be executed;
select at least one of the hardware processing units from the plurality of hardware processing units to perform the processing job based on a given process type of the processing job and the performance metrics of the hardware processing units for the given process type, wherein the selected at least one hardware processing unit is configured to process the processing job.

2. The device according to claim 1, wherein the hardware processing units include at least one of: a central processing unit (CPU); a graphics processing unit (GPU); a video decoder; a matrix multiplication unit; a neural engine block; an encryption engine; a decryption engine; or a hardware accelerator.

3. The device according to claim 1, wherein the data includes metric descriptor fingerprints and corresponding performance metrics.

4. The device according to claim 3, wherein one of the metric descriptor fingerprints includes any one or more of the following: a metric name; a processing unit identifier; a process type; a performance domain; a metric creator identifier; and a metric creation timestamp.

5. The device according to claim 3, wherein one or the performance metrics includes one or more of the following: a processing speed metric; a latency metric; a power consumption metric; a performance metric based on processing speed and latency; and a performance metric based on processing speed, latency and power consumption.

6. The device according to claim 1, further comprising a second hardware processing unit, wherein:
the second hardware processing unit is configured to cause a test process to be processed on at least some of the hardware processing units;
the at least some hardware processing units are configured to process the test process;
the second hardware processing unit is configured to perform measurements related to performance of the at least some hardware processing units processing the test process; and
the second hardware processing unit is configured to update the data of the performance metrics responsively to the performed measurements.

7. The device according to claim 1, further comprising a first die, a second die, and a data communication bus between the first die and second die, wherein the hardware processing units include a second hardware processing unit disposed on the first die and a third hardware processing unit disposed on the second die, the first hardware processing unit being configured to select the second hardware processing unit to perform at least part of the processing job based on the given process type of the processing job, and the performance metrics of the second hardware processing unit and the third hardware processing unit for the given process type.

8. The device according to claim 1, further comprising a system-on-chip comprising a first chiplet and a second chiplet, wherein the hardware processing units include a second hardware processing unit disposed on the first chiplet and a third hardware processing unit disposed on the second chiplet, the first hardware processing unit being configured to select the second hardware processing unit to perform at least part of the processing job based on the given process type of the processing job and the performance metric of the second hardware processing unit and the third hardware processing unit for the given process type.

9. The device according to claim 1, wherein the selected at least one hardware processing unit includes a second hardware processing unit and a third hardware processing unit, the first hardware processing unit being configured to apportion the processing job between the second hardware processing unit and the third hardware processing unit according to a ratio of the performance metrics of the second hardware processing unit to the third hardware processing unit.

10. The device according to claim 1, wherein the first hardware processing unit is configured to select the at least one hardware processing unit based on a maximum allowed latency of the processing job and at least one latency metric of the performance metrics of the hardware processing units for the given process type.

11. The device according to claim 10, wherein the selected at least one hardware processing unit includes a second hardware processing unit and a third hardware processing unit, the first hardware processing unit is configured to apportion the processing job between the second hardware processing unit and the third hardware processing unit of the hardware processing units according to a ratio of processing speed metrics of the performance metrics of the second hardware processing unit to the third hardware processing unit.

12. The device according to claim 1, wherein the first hardware processing unit is configured to select the at least one hardware processing unit based on at least one power consumption metric of the performance metrics of the hardware processing units for the given process type.

13. The device according to claim 12, wherein the first hardware processing unit is configured to select the at least one hardware processing unit based on the at least one power consumption metric responsively to the device being in a power save mode.

14. The device according to claim 1, wherein the first hardware processing unit is configured to run an operating system on which to execute the software code, which includes the processing job to be executed, the operating system being configured to select the at least one hardware processing units to perform the processing job based on the given process type of the processing job and the performance metrics of the hardware processing units for the given process type.

15. The device according to claim 14, wherein the operating system is configured to cause the at least one hardware processing unit to process the processing job.

16. A method, comprising:
storing data indicating performance metrics of hardware processing units;
executing software code, which includes a processing job to be executed;
selecting at least one of the hardware processing units to perform the processing job based on a given process type of the processing job and the performance metrics of the hardware processing units for the given process type; and
causing the at least one hardware processing unit to process the processing job.

17. An integrated circuit, comprising:
a memory configured to store data indicating performance metrics of hardware processing units; and
a first hardware processing unit configured to:
execute software code, which includes a processing job to be executed;
select at least one of the hardware processing units to perform the processing job based on a given process type of the processing job and the performance metrics of the hardware processing units for the given process type; and
cause the at least one hardware processing unit to process the processing job.

18. The integrated circuit according to claim 17, wherein the hardware processing units include at least one of: a central processing unit (CPU); a graphics processing unit (GPU); a video decoder; a matrix multiplication unit; a neural engine block; an encryption engine; a decryption engine; or a hardware accelerator.

19. The integrated circuit according to claim 17, wherein the data includes metric descriptor fingerprints and corresponding performance metrics.

20. The integrated circuit according to claim 19, wherein one of the metric descriptor fingerprints includes any one or more of the following: a metric name; a processing unit identifier; a process type; a performance domain; a metric creator identifier; and a metric creation timestamp.

21. The integrated circuit according to claim 19, wherein one or the performance metrics includes one or more of the following: a processing speed metric; a latency metric; a power consumption metric; a performance metric based on processing speed and latency; and a performance metric based on processing speed, latency and power consumption.

22. The integrated circuit according to claim 17, further comprising a second hardware processing unit, wherein:
the second hardware processing unit is configured to cause a test process to be processed on at least some of the hardware processing units;
the at least some hardware processing units are configured to process the test process;
the second hardware processing unit is configured to perform measurements related to performance of the at least some hardware processing units processing the test process; and
the second hardware processing unit is configured to update the data of the performance metrics responsively to the performed measurements.

23. The integrated circuit according to claim 17, wherein the selected at least one hardware processing unit includes a second hardware processing unit and a third hardware processing unit, the first hardware processing unit being configured to apportion the processing job between the second hardware processing unit and the third hardware processing unit according to a ratio of the performance metrics of the second hardware processing unit to the third hardware processing unit.

24. The integrated circuit according to claim 17, wherein the first hardware processing unit is configured to select the at least one hardware processing unit based on a maximum allowed latency of the processing job and at least one latency metric of the performance metrics of the hardware processing units for the given process type.

25. The integrated circuit according to claim 24, wherein the selected at least one hardware processing unit includes a second hardware processing unit and a third hardware processing unit, the first hardware processing unit is configured to apportion the processing job between the second hardware processing unit and the third hardware processing unit of the hardware processing units according to a ratio of processing speed metrics of the performance metrics of the second hardware processing unit to the third hardware processing unit.

26. The integrated circuit according to claim 17, wherein the first hardware processing unit is configured to select the at least one hardware processing unit based on at least one power consumption metric of the performance metrics of the hardware processing units for the given process type.

27. The integrated circuit according to claim 26, wherein the first hardware processing unit is configured to select the at least one hardware processing unit based on the at least one power consumption metric responsively to the integrated circuit being in a power save mode.
